(19) United States
(12) Patent Application Publication
(10) Pub. No.: US 2011/0248851 A1
(43) Pub. Date: Oct. 13, 2011

(54) Method for authenticating a person's identity by using a RFID card, biometric signature recognition and facial recognition.

(75) Inventor: THIEN VAN PHAM, POULSBO, WA (US)

(73) Assignee: THIEN VAN PHAM, POULSBO, WA (US)

(21) Appl. No.: 12/757,026

(22) Filed: Apr. 8, 2010

(51) Int. Cl. G08B 13/14

(52) U.S. Cl. 340/572.1

(57) ABSTRACT

A method is provided for validating an individual's identity by using a combination of a RFID card, signature captured by a touch screen computer, and a facial photo captured by a built-in camera of a touch screen computer. Using third party biometric signature recognition algorithms and facial recognition algorithms are preferred to differentiate the differences between a sample signature and facial photo referenced by a RFID card value.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to validating an individual's identity by using a RFID card value stored on the RFID card and to use that value to retrieve biometric signatures and a facial picture representing the individual and comparing it with a sample biometric signature and a facial photo using third party biometric signature recognition and facial recognition algorithms.

The process of validating an individual's identity has been a simple process by using username and password. Using this method is not secure because the username and password can be stolen by an onlooker or software written to record keystrokes. Using biometric signature is a secure method of authenticating an individual, but just biometric signature alone will not offer the full security necessary to validate an individual because a person trained at the art of recreating signature can compromise the system.

What is needed is a method for validating an individual's identity by using a combination of a RFID card, biometric signature recognition and facial recognition.

### BRIEF SUMMARY OF THE INVENTION

According to the invention, a method is provided for collecting a RFID card value, a sample biometric signature, and a facial photo.

In a typical application, the verification process would be performed by first reading the value on a RFID card, collecting a biometric signature, and taking a facial photo. Next, the RFID card value is then use to retrieve biometric signatures and a facial photo stored in a database and to use third party biometric signature recognition algorithms to compare the stored biometric signatures with the sample biometric signature collected and to use third party facial recognition algorithms to compare the facial photo stored in the database with the sample facial photo.

### BRIEF DESCRIPTION OF THE SEVERAL VIEWS OF THE DRAWING

FIG. 1 illustrates the individual components necessary for the present invention to operate.

FIG. 2 is a flow chart for reading RFID card value, capturing a sample biometric signature, and taking a facial photo using the touch screen computer.

FIG. 3 illustrates the validation process by comparing the sample signature and facial photo with a set of signatures and a facial photo stored in database.

### DETAILED DESCRIPTIONS OF THE INVENTION

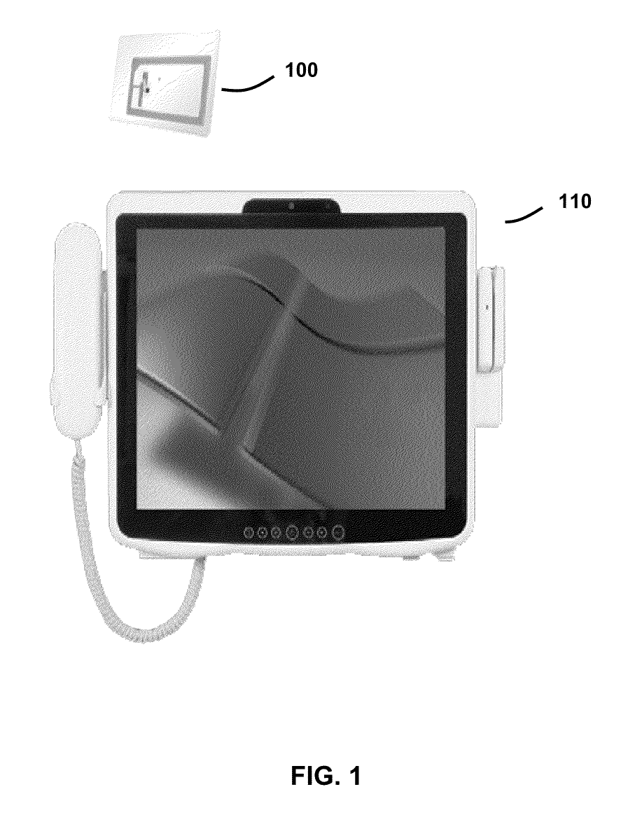

FIG. 1 illustrates the individual components necessary for the present invention to operate. The present invention is a software program. The RFID card 100 contains a unique alphanumeric string that can be read by an RFID card reader built into the touch screen computer 110. The touch screen computer 110 has the capability of capturing a signature directly from the screen with the movement of a person's finger or an attached computer mouse. The touch screen computer 110 has the capability of taking a facial photo with its built-in camera located above the touch screen computer 110 screen. The touch screen computer 110 runs the present invention which will capture the RFID card 100 value within 90 cm of being present to the touch screen computer 110. The present invention will then request the person to sign on the touch screen computer 110 and take a facial photo of the person using the built-in camera located above the touch screen computer 110 screen. The present invention will then use third party biometric signature algorithms to compare the sample signature with a set of stored biometric signatures in a database. The present invention will also use third party facial recognition algorithms to compare the sample facial photo with a facial photo stored in a database.

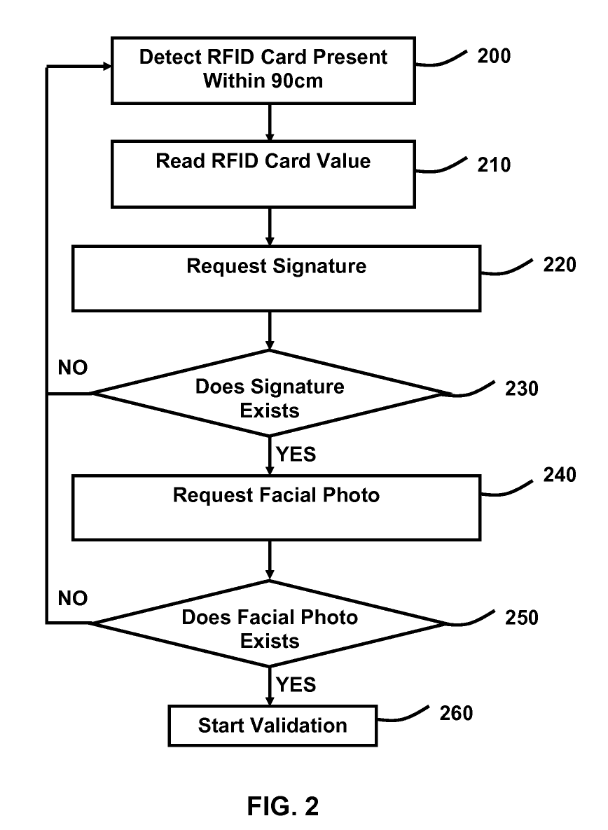

FIG. 2 illustrates a specific embodiment of the present invention, which is a computer software program. In step 200, the present invention continuously monitors for the presence of a RFID card 100 within a radius of 90 cm. If an RFID card 100 is present, the present invention continues to step 210. At step 210, the present invention reads the value from the RFID card 100 and continues to step 220. At step 220, the present invention waits for a predefined time period for the person to sign his/her signature on the touch screen computer 110 screen. If after the predefined time period is over, the present invention continues to step 230. At step 230, the present invention determines if a signature was collected in step 220. If there was no signature collected, the present invention continues back to step 200. If a signature was collected, the present invention continues to step 240. At step 240, the present invention instructs the person to stand directly in front of the touch screen computer 110 and waits for a predefined time period before taking a facial photo. Once the facial photo is taken, the present invention continues to step 250. At step 250, the present invention determines if a facial photo was taken in step 240. If a facial photo does not exist, the present invention continues back to step 200. If a facial photo exists, the present invention continues to step 260 and starts the validation process.

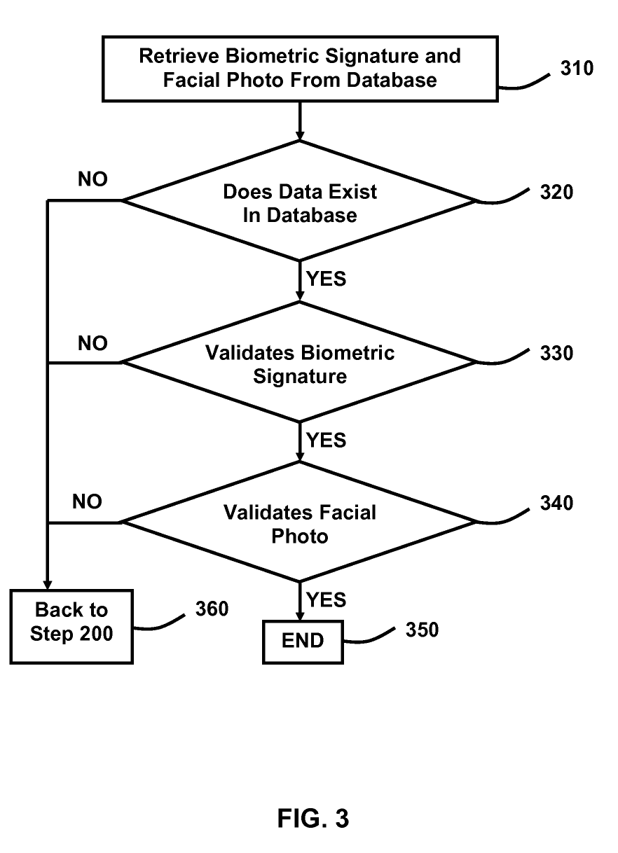

FIG. 3 illustrates a specific embodiment of the present invention, which is a computer software program. At step 310, the present invention connects to a database and retrieves biometric signatures and a facial photo using the RFID card 100 value collected at step 200 and continues to step 320. At step 320, the present invention verifies if there exists a set of biometric signatures and a facial photo stored in database. If there are no biometric signature and facial photo corresponding to the RFID card 100 value, the present invention continues to step 360, where the present invention steps back to step 200. If there are biometric signatures and a facial photo, the present invention continues to step 330. At step 330, the present invention uses third party biometric signature algorithms to validate the sample signature with the set of biometric signatures stored in database. If the validation process is not a success, then the present invention continues to step 360, where the present invention steps back to step 200. If the validation process is a success, then the present invention continues to step 340. At step 340, the present invention uses third party facial recognition algorithms to validate the sample facial photo with the facial photo stored in database. If the validation process is not a success, the present invention continues to step 360, where the present invention steps back to step 200. If the validation process is a success, the present invention continues to step 350, where the program ends.

This invention has now been explained with reference to specific embodiments. Other embodiments will be apparent to those of ordinary skill in the art in light of this disclosure. It is therefore not intended that this invention be limited except as indicated by the appended claims.

What is claimed is:

1. A method for validating an individual's identity using a combination of an RFID card, biometric signature recognition and facial recognition.
